(19) United States
(12) Patent Application Publication
(10) Pub. No.: US 2025/0150864 A1
(43) Pub. Date: May 8, 2025

(54) INFORMATION PROCESSING DEVICE

(71) Applicant: TOYOTA JIDOSHA KABUSHIKI KAISHA, Toyota-shi (JP)

(72) Inventors: Kazuya OKADA, Tokyo (JP); Hiroshi Abe, Kasukabe-shi (JP); Naoya Kaneko, Tokyo (JP); Toru Furusawa, Yokohama-shi (JP); Takayuki Sakai, Tokyo (JP); Koji Takeoka, Yokohama-shi (JP)

(73) Assignee: TOYOTA JIDOSHA KABUSHIKI KAISHA, Toyota-shi (JP)

(21) Appl. No.: 18/817,467

(22) Filed: Aug. 28, 2024

(30) Foreign Application Priority Data
Nov. 2, 2023 (JP) 2023-188165

(51) Int. Cl. H04W 24/08; H04L 43/0811; H04W 4/48

(52) U.S. Cl. CPC H04W 24/08; H04L 43/0811; H04W 4/48

(57) ABSTRACT

An information processing device acquires first data regarding the quality of wireless communication from the first apparatus, and acquires second data regarding the mobile environment of the first apparatus. Further, based on the plurality of first and second data, communication quality data, which is data obtained by mapping the quality of wireless communication to a geographical region, is generated for each segment of the mobile environment.

### CROSS-REFERENCE TO RELATED APPLICATION

This application claims priority to Japanese Patent Application No. 2023-188165 filed on Nov. 2, 2023, incorporated herein by reference in its entirety.

### BACKGROUND

### 1. Technical Field

The present disclosure relates to a communication technology.

### 2. Description of Related Art

There is a technique of determining a communication quality based on information transmitted from a mobile object that performs wireless communication. In this regard, Japanese Unexamined Patent Application Publication No. 2010-062783 (JP 2010-062783 A), for example, discloses a device that maps a communication quality obtained by a mobile terminal to a map based on probe data transmitted from the mobile terminal.

### SUMMARY

The present disclosure is directed to predicting the quality of wireless communication.

An aspect of an embodiment of the present disclosure provides
an information processing device including a control unit configured to: acquire first data about a quality of wireless communication from a first device;
acquire second data about a mobile environment of the first device; and
generate, for each segment of the mobile environment, communication quality data that are data obtained by mapping the quality of wireless communication to a geographical region based on a plurality of the first and second data.

Other aspects include a method that is executed by the above device, a program for causing a computer to execute the method, and a computer-readable storage medium storing the program in a non-transitory manner.

According to the present disclosure, it is possible to predict the quality of wireless communication.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle communication system according to a first embodiment;

FIG. 2 is a block diagram of an apparatus included in the system;

FIG. 3 is a diagram illustrating a specific example of probe data;

FIG. 4 is a diagram illustrating a specific example of communication quality data;

FIG. 5 is a sequence diagram of a process of transmitting probe data to a server device; and

FIG. 6 is a sequence diagram of a process of providing communication quality data to a vehicle.

### DETAILED DESCRIPTION OF EMBODIMENTS

In recent years, the connectivity of automobiles has advanced, and the number of vehicles having a wireless communication function has increased. Such a vehicle can communicate with a predetermined server device via, for example, a cellular communication network. In addition, with the popularization of automatic driving and the like, vehicles that require a constant connection with a server device have appeared.

In this connection, a technique for determining whether the quality of the wireless communication is kept good while the vehicle is traveling has been proposed. For example, by collecting information on the quality of wireless communication from a plurality of probe cars and mapping the information on the map, it is possible to generate a map (communication quality map) representing the quality of predicted communication for each location. Further, by using the communication quality map, it is possible to predict the quality of wireless communication in a vehicle traveling on a predetermined route.

The quality of the wireless communication may vary greatly depending on the moving environment of the vehicle. For example, millimeter-wave communication is characterized in that it can perform high-speed communication but is vulnerable to shielding. Therefore, in a case where a traffic jam occurs in the shadow of the building, there is a possibility that the communication quality is deteriorated and a predetermined service cannot be provided. On the other hand, in a case where the vehicle is running smoothly, a short-time communication quality degradation may not be a problem. In the related art, since the quality of communication is determined based only on the position information and the mobile environment of the communication terminal is not taken into consideration, it is not possible to accurately predict the quality of wireless communication. An information processing device according to the present disclosure solves such a problem.

An information processing device according to an aspect of the present disclosure includes a control unit that executes acquisition of first data related to quality of wireless communication from a first apparatus, acquisition of second data related to a mobile environment of the first apparatus, and generation of communication quality data, which is data obtained by mapping quality of wireless communication to a geographical region, based on the plurality of first and second data, for each segment of the mobile environment.

The first device is a mobile device having a wireless communication function. The first device may be, for example, a wireless communication device (in-vehicle device) mounted on a vehicle. The first data is data for reporting the quality of the wireless communication performed by the first apparatus. The first data may include measurements related to the quality of the communication, such as, for example, the received power and the received quality of the reference signal. The first data may include information about a wireless communication scheme used by the first apparatus. The information related to the radio communication scheme includes, for example, information identifying a communication standard (3G, LTE, 5G or the like), a frequency band (band), and the like. When the communication carriers providing the communication services are different, they may be regarded as different wireless communication schemes.

The second data is data related to the moving environment of the first device. As the data related to the moving environment of the first device, for example, the moving speed and the position information of the first device can be exemplified. The information processing device generates communication quality data for each mobile environment of the first apparatus. The communication quality data may be, for example, data obtained by mapping the measured communication quality on a map or a set of data. For example, in a case where the moving environment is classified by the moving speed band, the control unit may generate communication quality data for each classification corresponding to the moving speed band.

The communication quality data may be a set of communication quality maps corresponding to each of a plurality of wireless communication schemes available to the first apparatus.

For example, the control unit may generate a combination for a plurality of communication carriers, a communication standard, and a frequency band, and generate a communication quality map for each combination. These sets may also be treated as communication quality data.

The first data may include data identifying a wireless communication scheme used by the first apparatus, and the control unit may generate the communication quality map corresponding to the wireless communication scheme identified by the first data.

In addition, when receiving a request from the second apparatus, the control unit may transmit the communication quality data generated for each category of the mobile environment to the second apparatus.

The information processing device may provide the generated communication quality data to the second apparatus in response to a request from the second apparatus. According to such a configuration, it is possible to provide information for causing the second apparatus to select an appropriate wireless communication method.

The control unit may evaluate the quality of the wireless communication performed by the second device based on the communication quality data corresponding to the mobile environment of the second device when receiving a request including information about the mobile environment of the second device from the second device.

As described above, instead of providing the communication quality data to the second apparatus, the quality of the wireless communication performed by the second apparatus may be evaluated on the information processing device side based on the information regarding the mobile environment obtained from the second apparatus. This allows, for example, to teach a more appropriate (e.g., expected to obtain higher quality) wireless communication scheme to the second device.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

### Summary of System

An outline of the vehicle communication system according to the first embodiment will be described. The vehicle communication system according to the present embodiment includes a plurality of vehicles 1 and a server device 2. The vehicle 1 is a connected vehicle capable of accessing a wireless communication network. The vehicle 1 can communicate with the server device 2 and other external devices (e.g., an external device for providing a predetermined service, etc.) via a wireless communication network (e.g., a mobile communication network).

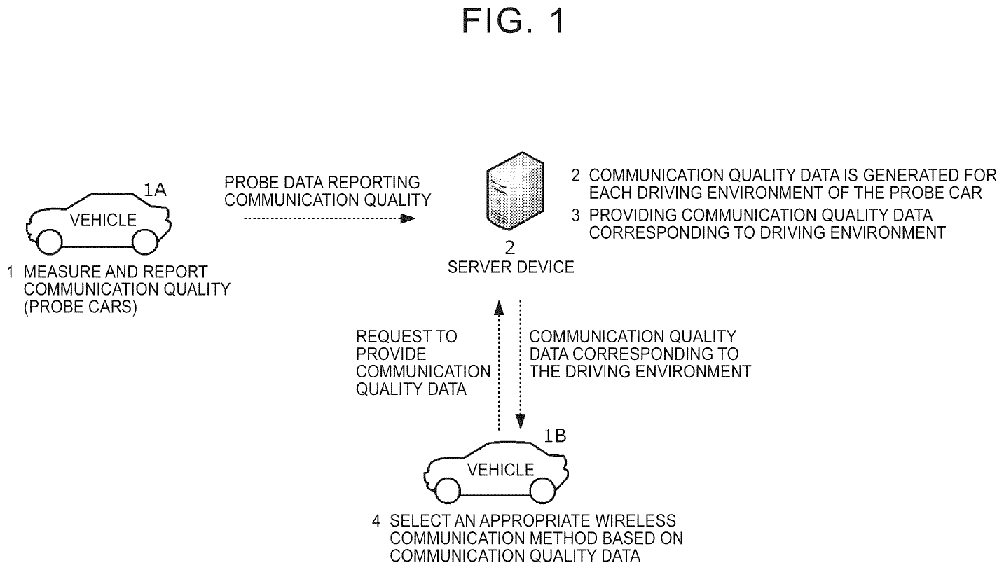

The vehicle 1 functions as both a vehicle (probe car) that measures quality related to wireless communication and provides the server device 2 with information on the result thereof, and a vehicle that receives information provision from the server device 2 and performs wireless communication on the basis of the acquired information. In FIG. 1, the former is distinguished as a vehicle 1A, and the latter is distinguished as a vehicle 1B. In the following explanation, the vehicle 1 (probe car) that provides information to the server device 2 is referred to as a vehicle 1A, and the vehicle 1 that receives information provision from the server device 2 is referred to as a vehicle 1B.

The vehicle 1 includes a data communication module (DCM hereinafter) for connecting a component (for example, a DCM or another ECU) of the vehicle to a network, and an in-vehicle device. In the present embodiment, the in-vehicle device can provide various services by communicating with an external device via a DCM. Examples of the various services include a navigation service, a remote control (e.g., remote air conditioning) service, an in-vehicle Wi-Fi (registered trademark) service, an emergency-call service, and a security service.

The server device 2 is a device configured to be able to communicate with a plurality of vehicles 1 via a network. The server device 2 receives a report (probe data) regarding communication quality from each of a plurality of managed vehicle 1A (probe cars). The server device 2 generates communication quality data that is data obtained by mapping the quality of wireless communication to a map based on the received probe data. At this time, the server device 2 generates communication quality data for each category of the traveling environment of the probe car. As an element for classifying the traveling environment, for example, a moving speed band of the vehicle 1 can be exemplified. For example, when the moving speed bands of the vehicles are grouped into N pieces, the server device 2 generates N sets of communication quality data.

When a request is received from the vehicle 1B, the server device 2 provides the generated communication quality data to the vehicle 1B. At this time, the server device 2 extracts communication quality data corresponding to the driving environment of the vehicle 1B and provides the communication quality data to the vehicle 1B. Accordingly, the vehicle 1B can acquire the communication quality data corresponding to the traveling environment of the host vehicle, and can select an appropriate radio communication method.

### Device Configuration

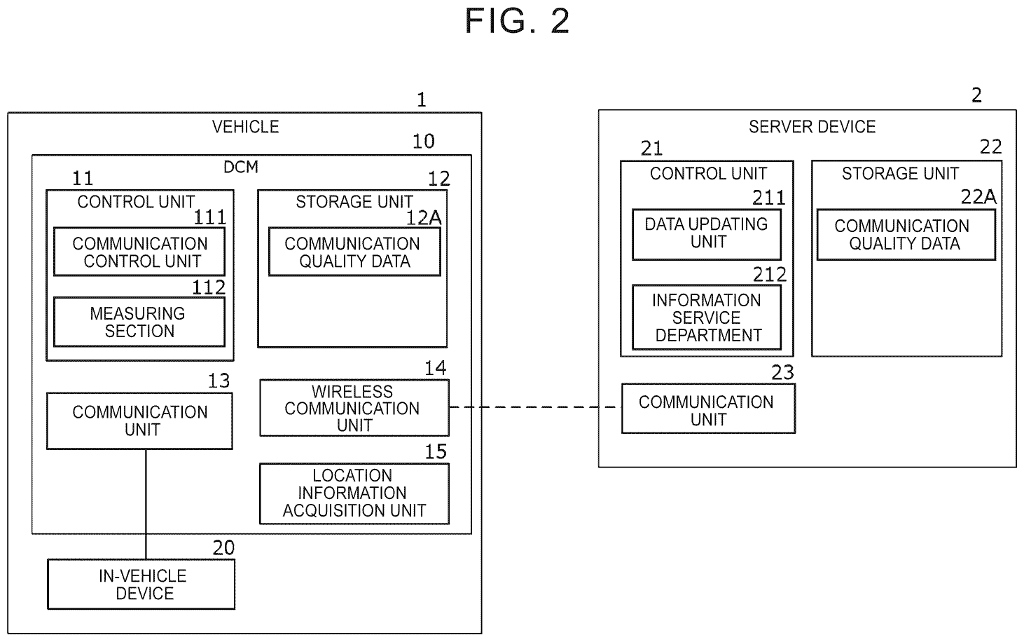

Next, the configuration of each device constituting the system will be described. FIG. 2 is a diagram schematically illustrating an example of a configuration of each device included in the vehicle communication system according to the present embodiment. The vehicle communication system according to the present embodiment includes one or more vehicles 1 and a server device 2.

First, components of the vehicle 1 will be described. The vehicle 1 includes a DCM 10 and an in-vehicle device 20.

DCM 10 is a device that wirelessly communicates with a predetermined network in order to connect a component (for example, the in-vehicle device 20) of the vehicle 1 to an external device (for example, the server device 2). In the present embodiment, DCM 10 is configured to be connectable to a predetermined cellular communication network. DCM 10 may be selectively connectable to a plurality of cellular networks provided by a plurality of operators, respectively. Further, DCM 10 is configured to be able to select a plurality of communication schemes (for example, a communication standard, a frequency band, and the like).

DCM 10 can be configured as a computer having a processor (such as a CPU, GPU), a main storage device (such as a RAM, ROM), and a secondary storage device (such as an EPROM, a hard disk drive, a removable medium, and the like). The secondary storage device stores an operating system (OS), various programs, various tables, and the like. By executing the program stored therein, it is possible to realize each function (software module) that meets a predetermined purpose, as will be described later. However, some or all of the functions may be realized as a hardware module by, for example, hardware circuitry such as an ASIC, FPGA.

DCM 10 includes a control unit 11, a storage unit 12, a communication unit 13, a wireless communication unit 14, and a position information acquisition unit 15.

The control unit 11 is an arithmetic unit that realizes various functions of the DCM 10 by executing a predetermined program. The control unit 11 can be realized by, for example, a hardware processor such as a CPU. In addition, the control unit 11 may be configured to include a RAM, Read Only Memory (ROM), a cache memory, and the like.

The control unit 11 includes two software modules, a communication control unit 111 and a measurement unit 112. The software modules may be implemented by executing programs stored in the storage unit 12 described later by the control unit 11 (CPU or the like).

The communication control unit 111 controls wireless connection to the cellular communication network. The communication control unit 111 attaches to the cellular communication network by a predetermined communication method, and establishes a communication path to the external device. When communication is generated from the components of the vehicle 1 toward the external device, the communication control unit 111 relays the communication to the cellular communication network. In addition, in a case where communication directed to a predetermined component is received from the cellular communication network, the communication control unit 111 relays the communication to the component. The communication control unit 111 is configured to be able to select a communication method to be used from a plurality of combinations. The wireless communication unit 14, which will be described later, performs cellular communication using the communication scheme selected by the communication control unit 111.

Further, the communication control unit 111 requests the server device 2 to periodically provide communication quality data, and adaptively changes the communication scheme to be used based on the communication quality data provided from the server device 2. Details of the processing will be described later.

The measurement unit 112 measures a value related to communication quality with respect to communication (cellular communication) performed by the communication control unit 111, and transmits a result of the measurement to the server device 2. In the present embodiment, the measurement unit 112 is configured to be capable of measuring the following values.

### Reference Signal Received Power (RSRP)

Reference signal received power is obtained by quantifying the strength (reception level) of the radio wave received from the base station in [dBm].

### Reference Signal Received Quality (RSRQ)

Reference signal received quality is an index obtained by quantifying the quality of the received reference signal in [dB].

Signal to Interference plus Noise Ratio (SINR)

Signal to interference plus noise ratio is an index obtained by quantifying the ratio of the power of the desired signal to the power of non-preferred signals (interference waves and thermal noise) in the received signal in [dB].

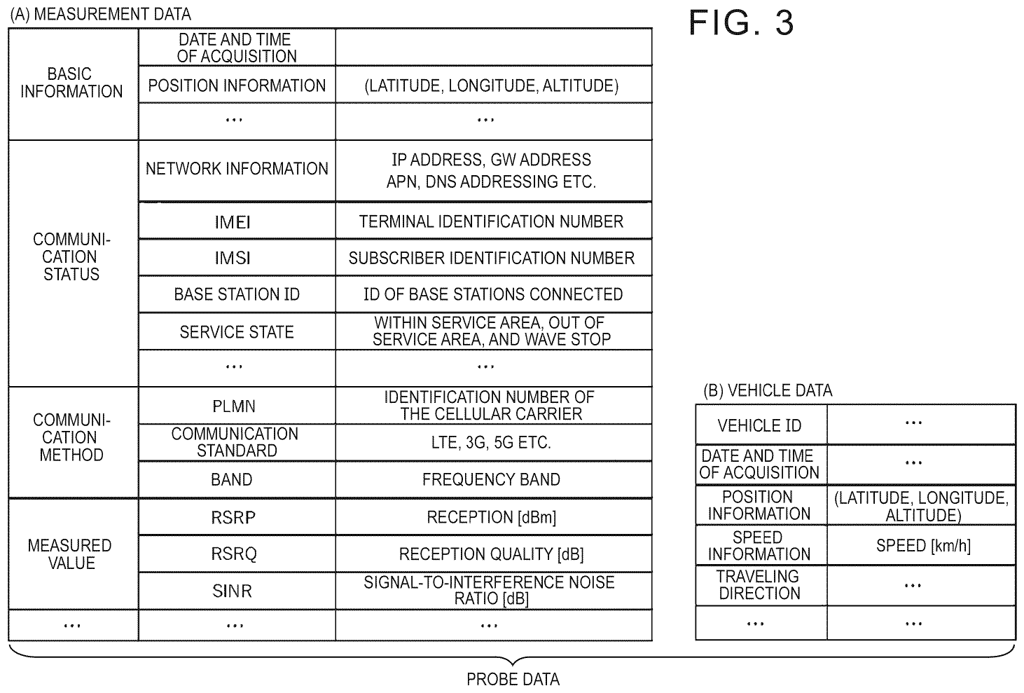

The measurement unit 112 periodically measures these values and transmits them as measurement data to the server device 2. The measurement data is an example of “first data”. (A) of FIG. 3 is an example of measurement data. In the present embodiment, the measurement data is composed of four sections: basic information, communication status, communication method, and measurement value.

The basic information section includes the acquisition date and time of the data and the position information of the vehicle 1. The position information of the vehicle 1 can be acquired from a position information acquisition unit 15 described later. The communication status section includes various types of status information in cellular communication. Examples of the status information include network information (such as an IP address, a gateway address, and APN information), a terminal identification number (IMEI), a subscriber identification number (IMSI), a base station ID being connected, and a service status.

The communication scheme section includes various types of information related to the communication scheme. Examples of the information related to the communication scheme include an identification number (PLMN) of a cellular communication carrier, a communication standard (3G, LTE, 5G, etc.), and a band (frequency band). The communication standard and the band may be set based on an instruction from the base station or may be designated by the communication control unit 111.

The measurement section includes a plurality of measurements related to the quality of the communication. In the present embodiment, as described above, three of RSRP (reference signal received power), RSRQ (reference signal received quality), and SINR (signal-to-interference-noise ratio) are subject to measurement.

Furthermore, the measurement unit 112 generates vehicle data and transmits the vehicle data to the server device 2 in addition to the measurement data. The vehicle data is a set of data related to the travel of the vehicle 1. (B) of FIG. 3 is an example of vehicle data. In the present embodiment, the vehicle data includes information on the position, speed, and traveling direction of the vehicle 1, and the like. These pieces of information may be acquired from the position information acquisition unit 15, or may be acquired from a sensor, an ECU, or the like included in the vehicle 1. The vehicle data is an example of “second data”.

In the following description, the set of vehicle data and measurement data is referred to as probe data. The measurement unit 112 periodically generates probe data and transmits the probe data to the server device 2.

The storage unit 12 is a unit that stores information, and is configured by a storage medium such as a RAM, a magnetic disk, or a flash memory. The storage unit 12 stores a program executed by the control unit 11, data used by the program, and the like. For example, the above-described vehicle data and measurement data are temporarily stored in the storage unit 12. Further, the storage unit 12 stores communication quality data 12A received from the server device 2. The communication quality data 12A will be described later.

The communication unit 13 is a communication interface with an in-vehicle network provided in the vehicle 1. The communication unit 13 performs communication via, for example, a controller area network (CAN) network or an in-vehicle Ethernet network. DCM 10 may communicate with in-vehicle devices 20 (and other ECU, etc.) via an in-vehicle networking.

The wireless communication unit 14 is a wireless communication interface for connecting the vehicle 1 to an external network. The wireless communication unit 14 is configured to be able to communicate with the server device 2 via a mobile communication network such as a wireless LAN, a 3G, 4G, or a 5G, for example.

The position information acquisition unit 15 acquires position information of the vehicle 1. The position information acquisition unit 15 includes GPS antennae and positioning modules for positioning the position information. The GPS antenna is an antenna that receives a positioning signal sent from a positioning satellite (also referred to as a global navigation satellite system (GNSS) satellite). The positioning module is a module that calculates the position information based on a signal received by the GPS antenna.

Next, the server device 2 will be described. Like DCM 10, the server device 2 can be configured as a computer including a processor (such as a CPU, GPU), a main storage device (such as a RAM, ROM), and a secondary storage device (such as an EPROM, a hard disk drive, and a removable medium).

The server device 2 includes a control unit 21, a storage unit 22, and a communication unit 23.

The control unit 21 is an arithmetic unit that realizes various functions of the server device 2 by executing a predetermined program. The control unit 21 can be realized by, for example, a hardware processor such as a CPU. In addition, the control unit 21 may be configured to include a RAM, Read Only Memory (ROM), a cache memory, and the like.

The control unit 21 includes two software modules, a data updating unit 211 and an information providing unit 212. The respective software modules may be realized by executing programs stored in the storage unit 22 described later by the control unit 21 (CPU or the like).

The data updating unit 211 receives probe data from a plurality of vehicles 1 (DCM 10), and generates or updates communication quality data based on the received probe data. In the present embodiment, the communication quality data is data obtained by mapping a value indicating the communication quality obtained when the cellular communication is performed by a predetermined communication method on a map. The communication quality data is stored in the storage unit 22.

When a request for providing communication quality data is made from the vehicle 1B, the information providing unit 212 generates communication quality data based on the stored communication quality data 22A, and transmits the communication quality data to the vehicle 1B. Details of processing performed by the data updating unit 211 and the information providing unit 212 will be described later.

The storage unit 22 is a means for storing information, and is composed of a storage medium such as a RAM, a magnetic disk, or a flash memory. The storage unit 22 stores a program executed by the control unit 21, data used by the program, and the like. In addition, the storage unit 22 stores communication quality data 22A.

The communication unit 23 is a communication interface for connecting the server device 2 to a network. The communication unit 23 is configured to be able to communicate with a network via, for example, Ethernet (registered trademark), a wireless LAN, a mobile communication network, or the like.

The configuration shown in FIG. 2 is an example, and all or a part of the functions shown in FIG. 2 may be executed using a specially designed circuit. Further, a program may be stored or executed by a combination of the main storage device and the auxiliary storage device other than the functions shown in FIG. 2.

### Overview of the Process of Generating and Providing Communication Quality Data

Next, an outline of a process in which the server device 2 generates communication quality data based on the probe data received from the vehicle 1A and provides the information to the vehicle 1B based on the generated communication quality data will be described.

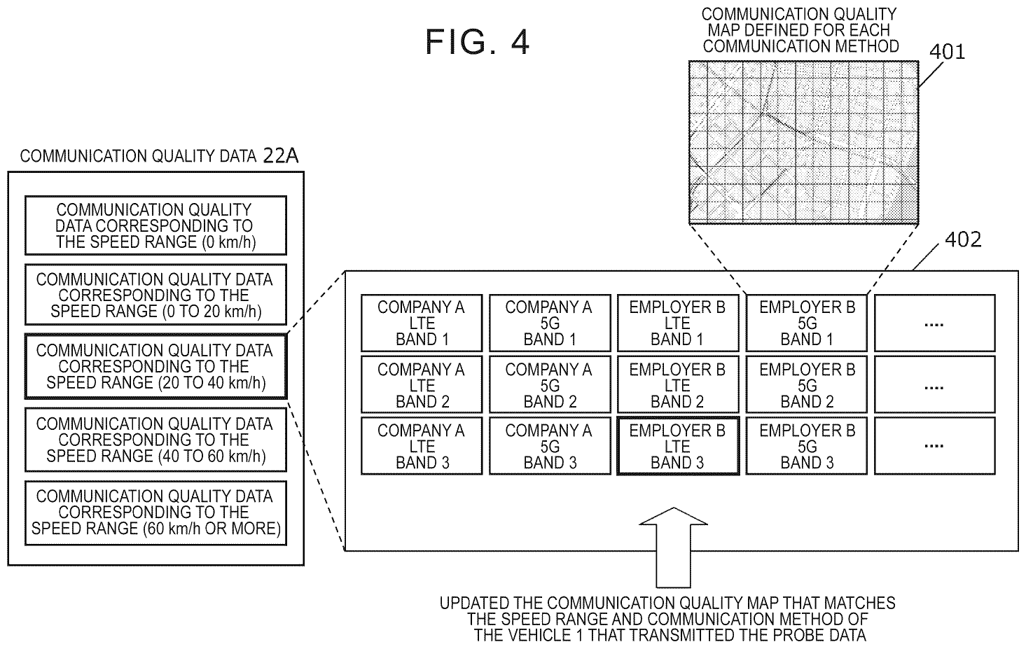

FIG. 4 is a schematic diagram illustrating a data configuration of a communication quality data 22A generated by the server device 2. In the present embodiment, the server device 2 generates the communication quality map based on the probe data received from the vehicle 1A. The communication quality map is data obtained by mapping the quality obtained when the cellular communication is performed by a specific communication method on a map. For example, the communication quality map may be obtained by dividing a geographical region included in a map by a unit region, and assigning an evaluation value representing the quality of wireless communication to each unit region. Reference numeral 401 denotes an example of a communication quality map. The evaluation value may be a discrete value or a continuous value.

For example, the communication quality map indicated by reference numeral 401 in FIG. 4 is obtained by mapping an evaluation value representing the quality obtained when the cellular communication is performed by the communication method “operator=B, communication standard=5G, frequency band=band 1” to a unit area on a map. As described above, the probe car measures RSRP, RSRQ and SINR as communication qualities. The evaluation value assigned to the unit area on the communication quality map may be any one of these values, or may be a value representing an overall quality obtained by integrating these values. By referring to the communication quality map, it is possible to predict the quality of communication at a certain point.

The server device 2 stores such a communication quality map for each communication method. In the server device 2, for example, a communication quality map is defined for each combination of a carrier, a communication standard, and a frequency band. When the probe data is received from the vehicle 1A, the server device 2 updates the corresponding communication quality map based on the probe data. For example, when the probe data is received from 1A of vehicles performing cellular communication by the communication system “operator=B, communication standard=5G, frequency band=band 1”, the communication quality map indicated by reference numeral 401 is an object to be updated. The evaluation value given to the communication quality map may be, for example, a weighted average of evaluation values obtained by a plurality of vehicles.

In the present embodiment, the server device 2 stores the communication quality data for each speed range. In the illustrated example, the server device 2 groups the speed ranges into five groups, and stores a plurality of communication quality maps for each speed range. The vehicle data constituting the probe data includes information indicating the velocity of the probe car (vehicle 1A). Upon receiving the probe data, the server device 2 identifies a speed range (for example, “20 km/h or more and less than 40 km/h”) to which the vehicle 1A belongs based on the information, and updates a communication quality map corresponding to the speed range and the communication method.

Further, when a request for providing communication quality data is received from the vehicle 1B, the server device 2 extracts one of the stored communication quality data that matches the vehicle 1B and provides the extracted communication quality data to the vehicle 1B. For example, the server device 2 provides the vehicle 1B with the communication quality data (reference numeral 402) corresponding to the speed range when the traveling speed of the vehicle 1B that has transmitted the request belongs to “20 km/h or more and less than 40 km/h”. The vehicle 1B stores the communication quality data as communication quality data 12A in the storage unit 12. By providing such information to the vehicle 1B, the vehicle 1B can determine “if the vehicle is traveling at a 20 km/h or more and less than 40 km/h, which communication method is used to obtain the best communication quality.”

Processing by which the Server Device 2 Updates Communication Quality Data

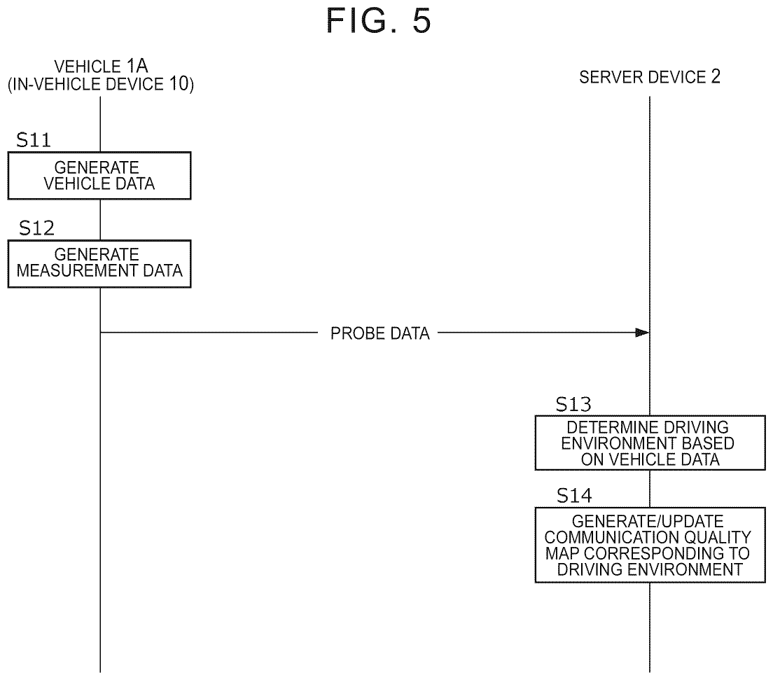

Next, a process in which the server device 2 collects probe data from a plurality of vehicle 1A and updates the communication quality data will be described. FIG. 5 is a sequence diagram of the processing. The process illustrated in FIG. 5 is periodically started by a DCM 10 mounted on the vehicle 1A. Further, the illustrated process is executed for each of the plurality of vehicle 1A managed by the server device 2.

It is assumed that a communication method used for cellular communication is set in advance in DCM 10 prior to the process shown in the drawing being started. The communication method may be a default communication method or a communication method selected adaptively based on the communication quality data received from the server device 2.

First, in S11, DCM 10 (measurement unit 112) generates vehicle-data. In the present embodiment, the vehicle data includes position information, velocity information, a traveling direction, and the like of the vehicle 1A. Such information may be acquired from an ECU or the like of the vehicle or may be acquired from an in-vehicle sensor (including the position information acquisition unit 15) via an in-vehicle network.

Next, in S12, DCM 10 (measurement unit 112) generates measurement data. The measurement value included in the measurement data may be measured by the wireless communication unit 14, for example. The measurement unit 112 transmits probe data including vehicle data and measurement data to the server device 2 (data updating unit 211).

In S13, the server device 2 (the data updating unit 211) determines the traveling environment (the speed range in the present embodiment) of the vehicle 1A based on the vehicle data included in the received probe data. In the present embodiment, the speed range is classified into five as illustrated in FIG. 4, but the number of classifications may be other than this.

In S14, the server device 2 (the data updating unit 211) generates or updates a communication quality map corresponding to the determined driving environment based on the measurement data included in the received probe data. For example, the data updating unit 211 specifies the unit area in which the vehicle 1A is located in the communication quality map, and updates the evaluation value corresponding to the unit area based on the measurement value included in the measurement data. When the target communication quality map has already been generated, the data updating unit 211 may calculate the updated evaluation value by a weighted average or the like with another vehicle.

Processing in which the Server Device 2 Provides Communication Quality Data

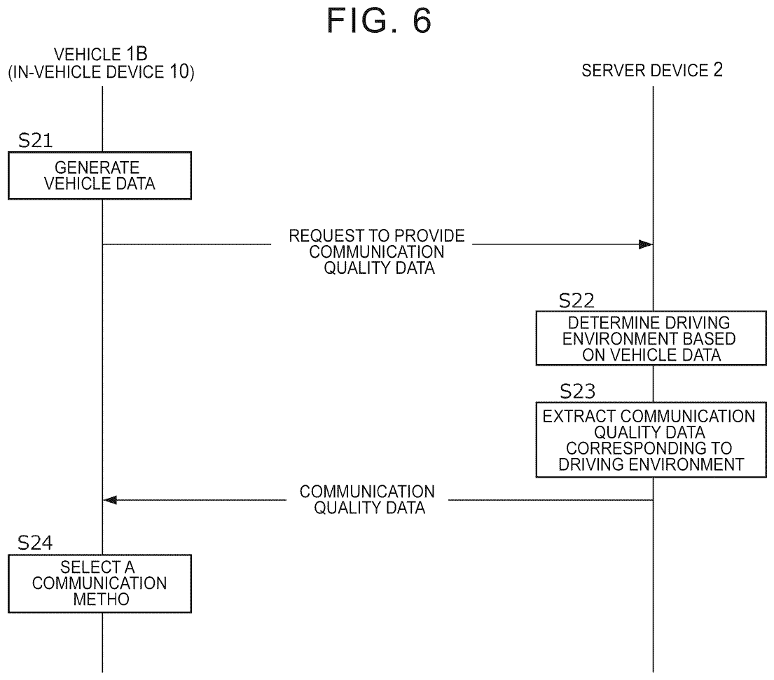

Next, a process in which the server device 2 receives a request for providing communication quality data from the vehicle 1B and provides communication quality data to the vehicle 1B will be described. FIG. 6 is a sequence diagram of the processing. The process illustrated in FIG. 6 is started by a DCM 10 mounted on the vehicle 1B. The process may be started when DCM 10 mounted on the vehicle 1B determines that the most recent communication quality data is required. For example, the process may be started at a predetermined cycle, or may be started when 1B of vehicles satisfies a predetermined criterion (for example, when the vehicle enters a new unitary area or when the traveling velocity range changes).

It is assumed that the communication quality data 22A corresponding to the respective speed bands are stored in the storage unit 22 in the server device 2 prior to the process shown in the drawing being started.

First, in S21, DCM 10 mounted on the vehicle 1B generates vehicle data as in S11. The vehicle data is included in the communication quality data provision request and transmitted to the server device 2.

Next, in S22, the server device 2 (the information providing unit 212) determines the traveling environment (the speed range in the present embodiment) of the vehicle 1B based on the vehicle data included in the provision request. Next, in S23, the server device 2 (information providing unit 212) extracts communication quality data corresponding to the speed range determined by S22 from the communication quality data 22A. For example, in FIG. 4, when it is determined that the velocity range of the vehicle 1B is “greater than or equal to 20 km/h and less than 40 km/h”, the server device 2 extracts the communication quality data indicated by reference numeral 402. The extracted communication quality data is transmitted to the vehicle 1B (DCM 10).

In S24, the communication control unit 111 included in the vehicle 1B (DCM 10) stores the communication quality data received from the server device 2 in the storage unit 12. Further, a suitable communication method is determined based on the communication quality data. In this step, for example, the communication control unit 111 refers to a plurality of communication quality maps defined for each communication method included in the received communication quality data, and specifies the communication method having the highest evaluation value in the unit region in which the host vehicle is located. In addition, the wireless communication unit 14 is notified that the communication method is used, and the communication method is switched.

It should be noted that the switching of the communication method is not necessarily performed for each unit area, and it is not necessary to always select the communication method with the highest evaluation value. For example, the communication method may be switched in a case where the evaluation value is lower than a predetermined value (or is expected to decrease in the future) or in a case where the evaluation value is increased by a predetermined value or more before and after the switching with respect to the currently used communication method. In addition, the communication method may be switched in a case where a trouble occurs in normal communication, such as a time-out occurs, or in a case where a trouble occurs in the future. In particular, when the communication carrier is switched, it takes a certain time to attach to the cellular communication network. Therefore, the switching of the communication carrier may be performed only in a case where the communication quality required by the communication carrier before the switching cannot be secured. In addition, in a case where the merit is larger even if time is spent for switching the communication method, the communication method may be switched.

As described above, in the vehicle communication system according to the present embodiment, the server device 2 generates data (communication quality data) in which the communication quality is mapped on a map for each traveling environment (speed range) of the vehicle based on the probe data transmitted from the vehicle 1A that is the probe car. In addition, when a request is received from the vehicle 1B, communication quality data corresponding to the traveling environment (velocity range) of the vehicle 1B is extracted and provided. According to this configuration, even in a case where the quality of the wireless communication changes for each traveling environment of the vehicle, it is possible to provide appropriate information for selecting the communication method to the vehicle.

In the first embodiment, the traveling speed range of the vehicle is exemplified as the traveling environment of the vehicle, but other elements may be treated as the traveling environment. For example, the traveling environment of the vehicle may be determined based on information about an attribute of a road on which the vehicle is traveling (for example, a general road, an expressway, an automobile dedicated road, a bridge, a tunnel, a number of lanes, and the like), a traveling direction of the vehicle, a surrounding environment of the vehicle (for example, presence or absence of a traffic jam, and the like), and the like. Even in this case, as illustrated in FIG. 4, the server device 2 generates and stores communication quality data for each traveling environment of the vehicle.

### Second Embodiment

In the first embodiment, the server device 2 transmits the communication quality data corresponding to the driving environment of the vehicle 1 to the vehicle 1 (DCM 10) that has requested the provision of the communication quality data. Further, DCM 10 determines a suitable communication method based on the received communication quality data.

On the other hand, the determination of a suitable communication scheme may be performed in the server device 2. In other words, S24 process may be performed by the server device, and only the outcome may be notified to DCM 10. In this case, the server device 2 (the information providing unit 212) may execute a process of determining a communication method suitable for the vehicle 1 based on the position information of the vehicle 1 after S23 process is completed. The content of the process of determining the communication method is the same as that of S24. The server device 2 (information providing unit 212) may notify the vehicle 1 (DCM 10) of the determined communication method, and DCM 10 (communication control unit 111) may perform switching to the communication method.

### Third Embodiment

In the first to second embodiments, DCM 10 determines the driving environment (speed range) of the respective vehicles by using the speed information included in the probe data. On the other hand, the speed of each vehicle may not be acquired directly from the vehicle.

For example, a case where the position information is periodically transmitted from the vehicle 1 to the server device 2 (for example, at intervals of 5 seconds) will be considered. In such a case, the server device 2 can acquire the transition of the position of the vehicle 1 over time on the basis of the periodically acquired position information. Therefore, in this case, the speed of the target vehicle can be estimated on the server device side without including the speed information in the probe data. Here, the position information transmitted from the vehicle 1 is also an example of “second data”. In the case where the position information is included in the measurement data, the same processing may be performed based on the position information included in the measurement data.

### Modified Examples

The above-described embodiments are merely examples, and the present disclosure may be appropriately modified and implemented without departing from the scope thereof. For example, the processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (floppy disk, hard disk drive (HDD), etc.), optical disk (CD-ROM, DVD disk, Blu-ray disk, etc.), read-only memory (ROM). Non-transitory computer-readable storage media include, for example, random access memory (RAM), EPROM, EEPROM, magnetic cards, flash memory, optical cards, any type of media suitable for storing electronic instructions.

What is claimed is:

1. An information processing device comprising a control unit configured to
acquire first data about a quality of wireless communication from a first device,
acquire second data about a mobile environment of the first device, and
generate, for each segment of the mobile environment, communication quality data that are data obtained by mapping the quality of wireless communication to a geographical region based on a plurality of the first and second data.

2. The information processing device according to claim 1, wherein the communication quality data are a collection of communication quality maps corresponding to a plurality of wireless communication schemes that is available to the first device.

3. The information processing device according to claim 2, wherein:
the first data include data that identify a wireless communication scheme that is used by the first device; and
the control unit generates a communication quality map corresponding to the wireless communication scheme identified by the first data.

4. The information processing device according to claim 1, wherein when a request is received from a second device, the control unit transmits the communication quality data generated for each segment of the mobile environment to the second device.

5. The information processing device according to claim 1, wherein when a request that includes information about a mobile environment of a second device is received from the second device, the control unit evaluates a quality of wireless communication performed by the second device based on communication quality data corresponding to the mobile environment of the second device.
